(19) United States
(12) Patent Application Publication
(10) Pub. No.: US 2026/0004342 A1
(43) Pub. Date: Jan. 1, 2026

(54) FINANCIAL CREDIT SCORE DETERMINATION AND REPORTING METHOD

(71) Applicant: Tia Chabot, Sexsmith (CA)

(72) Inventor: Tia Chabot, Sexsmith (CA)

(21) Appl. No.: 18/754,727

(22) Filed: Jun. 26, 2024

(51) Int. Cl. G06Q 40/03

(52) U.S. Cl. CPC G06Q 40/03

(57) ABSTRACT

A method of determining and producing a credit score for an individual wherein the method has a process flow facilitating stability and standardization in areas of timelines, data capture information and storage guidelines. The method utilizes a discrete timeline capture of financial data that is subsequently employed in a timeline cycle of the method producing a credit score that cannot be changed for a specified time period. The method includes a thirty day timeline cycle that that includes an initial step of data collection. A step of uploading data to credit agencies occurs in the beginning of the timeline cycle. Ensuing initial calculation of a credit score, the credit score is sent to the consumer for review of errors and omissions. Subsequent validation of any errors and omissions, the credit score is established and a lockout period begins inhibiting any changing of the credit score.

### FIELD OF THE INVENTION

The present invention relates generally to financial measurement parameters, more specifically but not by way of limitation, a method of determining and producing a credit score for an individual wherein the method of the present invention has a process flow facilitating stability and standardization in areas of timelines, data capture information and storage guidelines and further should provide weightings and scoring that are proportional and reflect positive reinforcement.

### BACKGROUND

Credit scores are a numerical expression of your creditworthiness and how an individual has managed credit and debt. Understanding how credit scores work can help an individual improve parameters such as credit history, which allows the individual to qualify for lower interest rates on loans. A credit score is a three-digit number that provides a snapshot of an individual's creditworthiness with popular credit scoring models use a range of 300 to 850. Credit scores are calculated using the information found in credit reports, such as how many credit accounts, length of time open, payments history, account balances and other similar parameters. The primary objective of a credit score is to indicate how likely an individual is to repay a loan on time. When an individual applies for a loan or credit card, the lender will typically use the credit score, along with other information, to determine whether an individual qualifies and what loan terms, including the interest rate and fees, will be for the term of the loan. Lenders use credit scores to make these decisions they are a good predictor of how likely the applicant is to pay back a loan or credit card balance and make payments on time. In many cases, lenders will set a minimum credit score requirement that an individual must meet to have a chance of being approved for a loan or credit card. If the credit score meets the threshold, lenders will also consider income, existing debt and other parameters of an individual's credit history to determine whether to approve the loan or credit card application.

Credit scores and in-depth reporting are key financial indicators of creditworthiness and financial integrity in a credit-driven society, notably Canada. Having a credit score and report is a forced obligation controlled by an oligopoly in Canada consisting of TransUnion and Equifax. In a normal course of business, consumers choose whom to give their loyalty to, but with credit rating agencies, consumers are forced to provide loyalty; it is not a choice. Consumers are not given the option between the two organizations. Banks and other lenders decide with whom they would like to build a relationship, and that is where the credit report and score are obtained. Identifying individual components of the score and report, the surveys have been gathered collecting data on specific areas such as gender, education, income level to explore their interactive relationship to the understanding of how Canadian credit is scored. Data has supported the hypotheses that credit is a shadow game and that regardless of characteristics, there is no correlation between them and an understanding of the credit scoring system. Data also indicated based on the small data set that Canadians agree a new system with a scoring rubric that they relate to is needed. A new iteration of credit scoring and reporting, including new parameters that are measurable, transparent, simple, and unambiguous is needed for consumers. A new credit scorecard should feature an eighty-twenty division of regulated credit weighting versus deregulated credit weighting.

Accordingly, there is a need for a new credit scoring system having a process flow facilitating stability and standardization in areas of timelines, data capture information and storage guidelines. Furthermore, a new system should provide weightings and scoring that are proportional and reflect positive reinforcement.

### SUMMARY OF THE INVENTION

It is the object of the present invention to provide a method for calculating, generating and reporting a credit score for an individual wherein the present invention wherein all credit data inputs are captured at a single static period of time.

Another object of the present invention is to provide a credit score calculation and reporting method wherein the present invention includes holding of additional credit data inputs for a subsequent transformation date.

A further object of the present invention is to provide a method for calculating, generating and reporting a credit score for an individual wherein the present invention includes a step of consumer review of the credit score prior to the credit score being published.

Yet a further object of the present invention is to provide a credit score calculation and reporting method wherein the present invention includes production of a credit score output that is valid for a certain time period.

Still another object of the present invention is to provide a method for calculating, generating and reporting a credit score for an individual wherein the present invention utilizes a scoring system for a credit score that employs a scale of zero to one hundred percent.

An additional object of the present invention is to provide a credit score calculation and reporting method wherein the present invention that includes a step of devaluing a credit score for a consumer missed payment equally regardless of other parameters.

Yet a further object of the present invention is to provide a method for calculating, generating and reporting a credit score for an individual wherein the present invention includes only numerical values for computation of a credit score and does not employ behavioral data parameters.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a chart of the timeline cycle of the method of the present invention; and

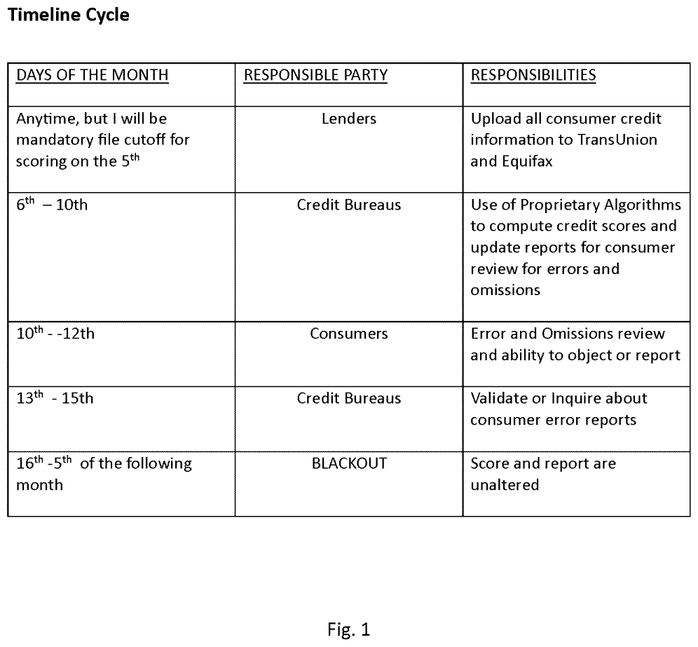

FIG. 2 is a chart of the scoring framework of the present invention; and

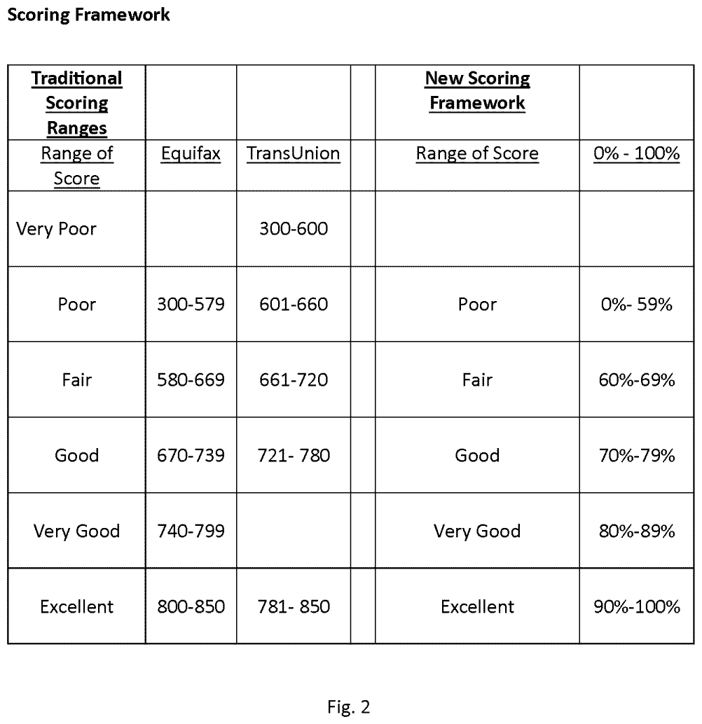

FIG. 3 is a chart of the scoring framework of the present invention; and

FIG. 4 is a flowchart of the process of the present invention.

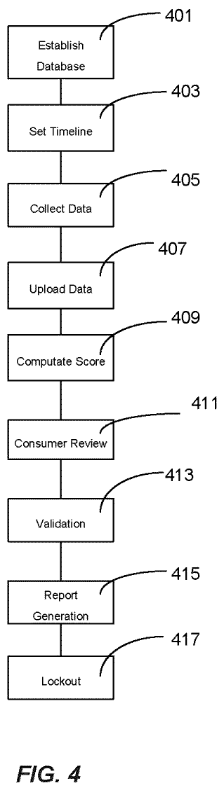

### DETAILED DESCRIPTION

Referring now to the drawings submitted herewith, wherein various elements depicted therein are not necessarily drawn to scale and wherein through the views and figures like elements are referenced with identical reference numerals, there is illustrated a credit score generation method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the credit score generation method 100 is operable to collect data from various financial institutions and lenders wherein the information is utilized to generate a credit score for a consumer. Furthermore, the collection of the financial data is performed during a finite period and the credit score generation is subsequently unchanged for a length of time. The credit score generation method 100 initiates with establishing a database in step 401. The database of the present invention is a conventional database wherein the database employs conventional computers and software to store profile information about consumers and have financial parameter data received associated with each consumer profile. It should be understood within the scope of the present invention that the database could operate on various types of computer technology such as but not limited to cloud-based technology. Step 403, the timeline cycle for the credit score generation method 100 is established. In a preferred embodiment of the present invention, the timeline cycle for collection, computation, validation and credit score generation occurs in thirty day increments as is further discussed herein. It is contemplated within the scope of the present invention that the timeline cycle could be set at alternate lengths that are greater than or less than thirty days.

In step 405, the operator of the credit score generation method 100 collects financial lending data from all sources such as but not limited to financial institutions and other lenders. The financial data includes data regarding any of the four types of debt that a consumer could possess which includes revolving debt, installment debt, open source debt and mortgage debt. The collection of the aforementioned data is stored in the database with each consumer profile. In step 407, the operator of the credit score generation method 100 uploads the financial data to the credit agencies such as but not limited to Equifax. The operator will upload the recently collected data during day one through day five of the thirty day timeline cycle of the present invention. Step 409, the credit agencies utilize algorithms to perform computation employing the data so as to generate a credit score. As is discussed herein the credit score utilizes a percentage scale based on one hundred percent. The computation occurs on day six through day ten of the thirty day timeline cycle of the credit score generation method 100. In step 411, the credit score generated by the credit agencies is delivered to each consumer having a profile. At this point in the timeline cycle, only the consumer has received their credit score with no other entities being in receipt of the credit score. Upon receipt the consumer reviews the credit score and associated report and performs a review for any errors and omissions that might have occurred. The consumer review takes place on day ten through day twelve of the timeline cycle of the credit score generation method 100.

Step 413, the credit agencies perform a validation of the errors and omissions identified by the consumers. The validation of the errors and omissions can include interaction with the consumers and occurs on day thirteen through day fifteen of the thirty day timeline cycle of the credit score generation method 100. Step 415, the operator of the credit score generation method 100 will generate a finalized credit score that is provided to the consumer as well as other entities. The final score is produced on day sixteen of the thirty day timeline cycle. During the timeline cycle day sixteen through day thirty is a lockout period, occurring as step 417 in the method of the present invention. During this period no financial data parameters are collected or utilized wherein the credit score will remain unimpacted during this time period of step 417.

Existing credit scoring operations process design employs a continuous inputs technique wherein the financial data parameters are input into the scoring as obtained continuously. Each input affects the credit score which results in a volatile and unpredictable methodology. As discussed herein the present invention employs a process flow starting with the inputs. All data used to recalculate a credit score flows in for a discrete time period and is collected as opposed to the continuous collection of data inputs. All creditors and lending organizations, including primary, secondary, and tertiary lenders, transmit inputs to TransUnion and Equifax during the collection stage. Once the calculation of the inputs begins, no additional data that can be added or changed. Any subsequent inputs are collected and held for the next transformation date. During this transformation time, data is recalculated, and the report is updated. The change of score and report is then uploaded to a platform where the consumer reviews and advises the credit agencies if there are errors or omissions before it is made public. The new credit score flows from transformation to an output. This final output is guaranteed to be dependable for a specified period of days during the timeline cycle as discussed herein.

Aligning timelines concerning stored information and removing aspects of information that invade privacy provides a more dependable service. Bankruptcies can be completed in either nine months or twenty-one months. If all the requirements have been satisfied at the time of bankruptcy, there is a complete discharge. If not all terms have been settled, discharge is not granted and becomes conditional until all requirements have been completed within a period. The time bankruptcy information is included in a credit report is not the same as its impact on the score. The score of an open bankruptcy impacts the score negatively as long as the bankruptcy is unresolved. The information contained in the credit report would continue to acknowledge and update the consumer file with updates. Individuals in bankruptcy are typically not permitted to have any credit obligations. Seven years captures the point of initial bankruptcy through nine through twenty-one months, discharge, and five years of rebuilding information. Aligning a seven year time frame across all information storage provides the best medium timeframe that captures the strongest amount of current information.

All consumer credit granting organizations, including sub-prime and private lenders are required to report to credit bureaus/agencies, including all mortgage companies. Consumers require a credit score, and all parts of their credit should be included; this protects lenders from being ignorant by overextending a consumer without knowledge, and it protects a consumer by accurately reporting and scoring them on all information. This framework provides expectations that can be delivered regularly and consistently, which are the deliverables of dependability. Consumers are able to opt in or out, to the use their data being harvested and sold in the present invention.

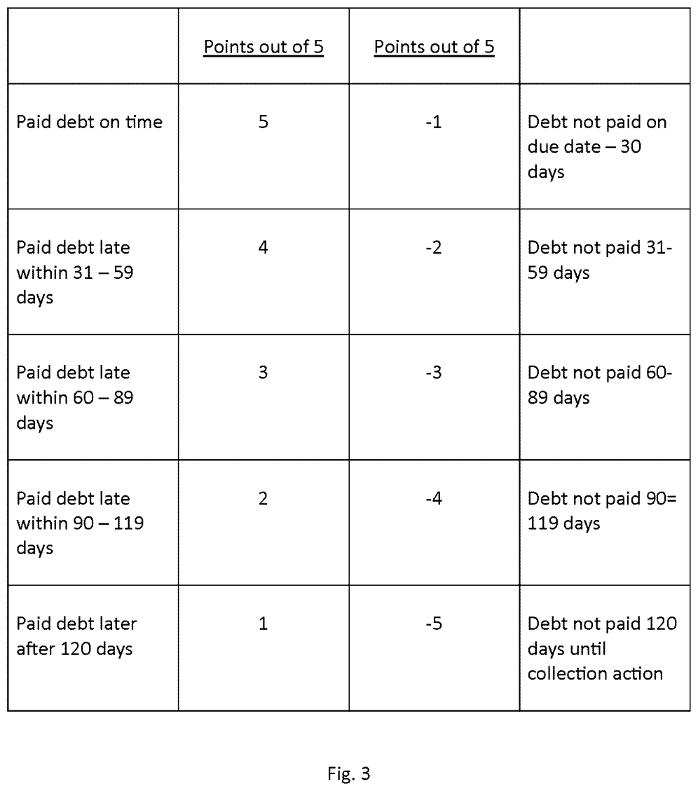

Within the scope of the present invention, missing a payment holds the same consequence for all consumers. Those with higher credit scores will not lose more points, as this provides inequality in scoring. FIG. 3 submitted as a part hereof outlines an example of equality in positive and negative decisions concerning repayment history, eliminating existing bias with current methodologies. Negative financial decisions have negative consequences, such as collections, bankruptcy, missed payments, or exceeding credit limits given. The scoring framework of the present invention ensures the primary categories are unchanged, but that the credit agencies have the same weight in each area, allowing the remaining twenty percent of the score to have some proprietary computation. The scoring framework of the present invention requires that behavioral scoring components must remain on the report side, and the credit score is designed to have no behavioral elements for scoring, only computations with numerical values.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method of determining and producing a credit score for an individual wherein the method of the present invention comprises the steps of:
establishing a database, said database being stored on at least one computer wherein the computer includes electronic components operable to receive, store, transmit and manipulate data;
collecting financial data parameters, wherein an operator of the method collects financial data parameters on consumers from financial institutions and lenders, wherein the financial data parameters are stored in the database and associated with a profile for each consumer that the financial data pertains thereto;
establishing a timeline cycle, wherein the operator of the method establishes a timeline cycle for the discrete operation of the method;
uploading the financial data parameters, wherein the operator of the present invention uploads the financial data parameters captured during a first discrete time period to credit agencies;
computing a credit score, wherein the credit agencies compute a credit score utilizing the financial data parameters;
transmitting the credit score and a credit report to the consumer, wherein the credit score is transmitted to the consumer;
reviewing the credit report, wherein the credit report is reviewed by the consumer for errors and omissions;
validating the credit score, wherein the credit agency validates the credit score;
generating a second credit report and credit score, wherein the credit score is published to inquiring entities;
restricting updates to the credit score, wherein the operator of the method restricts data input for calculation of a subsequent credit score until a second timeline cycle of the method is initiated.

2. The method of determining and producing a credit score for an individual as recited in claim 1, wherein the step of collecting financial data parameters occurs over a discrete time period.

3. The method of determining and producing a credit score for an individual as recited in claim 2, wherein the timeline cycle of the method is thirty days.

4. The method of determining and producing a credit score for an individual as recited in claim 3, wherein the step of uploading the financial data parameters occurs from day one through day five of the timeline cycle.

5. The method of determining and producing a credit score for an individual as recited in claim 4, and further including a step of retaining additional financial data inputs, wherein the additional financial data inputs are retained during an existing timeline cycle for use in a subsequent timeline cycle.

6. The method of determining and producing a credit score for an individual as recited in claim 5, wherein the credit score produced by the method of the present invention is from 0 to 100 percent.

7. The method of determining and producing a credit score for an individual as recited in claim 6, wherein the step of computing a credit score occurs from day six through day ten of the timeline cycle.

8. The method of determining and producing a credit score for an individual as recited in claim 7, wherein the step of reviewing the credit report occurs from day ten through day twelve of the timeline cycle.

9. The method of determining and producing a credit score for an individual as recited in claim 8, and further including a step of factoring a negative financial outcome into the credit score.

10. The method of determining and producing a credit score for an individual as recited in claim 9, wherein the step of restricting updates to the credit score occurs from day sixteen through day thirty of the timeline cycle.

11. The method of determining and producing a credit score for an individual as recited in claim 10, wherein the step of retaining additional financial data inputs transpires from day five of a first timeline cycle through day thirty of the first timeline cycle.

12. The method of determining and producing a credit score for an individual as recited in claim 11, and further including a step of executing a second timeline cycle, wherein the second timeline cycle commences upon expiration of the first timeline cycle.
